(19) United States
(12) Patent Application Publication
(10) Pub. No.: US 2015/0124222 A1
(43) Pub. Date: May 7, 2015

(54) DISPLAY DEVICE

(71) Applicant: NITTO DENKO CORPORATION, Ibaraki-shi, Osaka (JP)

(72) Inventor: Noriyuki Juni, Ibaraki-shi (JP)

(73) Assignee: NITTO DENKO CORPORATION, Ibaraki-shi, Osaka (JP)

(21) Appl. No.: 14/381,442

(22) PCT Filed: Mar. 13, 2013
(86) PCT No.: PCT/JP2013/056921

§ 371 Date: Aug. 27, 2014

(30) Foreign Application Priority Data
Mar. 30, 2012 (JP) 2012-081248
Nov. 13, 2012 (JP) 2012-249682
Mar. 5, 2013 (JP) 2013-043074

(51) Int. Cl. G02B 27/22

(52) U.S. Cl. CPC G02B 27/2292; G02B 5/09
USPC 353/10

(57) ABSTRACT

A display device according to the present invention includes a mounting stand having a display mounting surface for removably placing an electronic device having a flat panel display thereon, a panel-shaped image-forming optical element, and a case, housing or the like for housing the electronic device therein. The image-forming optical element is disposed on an upper surface of the case or the like. The display mounting surface is disposed under the image-forming optical element at a predetermined inclined angle with respect to a lower surface of the image-forming optical element. A projected image of a video picture displayed on the display is image-formed in a manner floating up over the image-forming optical element by means of light projected from the display of the electronic device placed on the display mounting surface and transmitted through the image-forming optical element.

### TECHNICAL FIELD

The present invention relates to a display device which projects a two-dimensional image such as a photograph in a manner floating above in space to thereby three-dimensionally display an image with a sense of depth.

### BACKGROUND ART

Heretofore, there has been known an image display device which includes: an image display surface (liquid crystal display panel and the like) for displaying an image including a three-dimensional image; and an image transmission panel (image-forming optical element) provided on the near side (viewer side) of the image display surface in spaced apart relation to the display surface and for forming the aforementioned image in space (with reference to Patent Literature 1 and the like, for example).

This image display device is provided with a pair of microlens arrays (image-forming optical element) positioned in a parallel spaced-apart relation to the aforementioned image display surface and including a plurality of convex lenses (unit optical elements) disposed adjacent to each other in a matrix on opposite surfaces. Using the image-forming function of the microlens arrays, the image display device is capable of projecting (forming) an erect image of unity magnification corresponding to the aforementioned image in a space opposite from the aforementioned display surface (in a position opposite from the display surface with respect to the element surface of the aforementioned image-forming optical element).

### CITATION LIST

### Patent Literature

PTL 1: Japanese Published Patent Application No. 2003-98479

### SUMMARY

However, in the aforementioned conventional image display device, a video picture displayed on the display surface of the aforementioned liquid crystal display panel and the like is image-formed at the front of the aforementioned optical element (microlens arrays) (that is, at the front of the image display device). This results in a problem such that the frame of the device and the like come into the field of view of a viewer, so that it is difficult to obtain a three-dimensional effect, a sense of realism and the like.

In view of the foregoing, it is therefore an object of the present invention to provide a display device capable of displaying a two-dimensional image rich in a sense of depth and appearing three-dimensional in a manner floating up in space apart from the body of the device.

To accomplish the aforementioned object, a display device according to the present invention comprises: a mounting stand having a display mounting surface for placing a flat panel display thereon; a panel-shaped image-forming optical element; and a case for housing said display therein, said image-forming optical element being disposed on an upper surface of the case, said display mounting surface being disposed under the image-forming optical element at a predetermined inclined angle with respect to a lower surface of said image-forming optical element, wherein a projected image of a picture displayed on said display is image-formed in a manner floating above the image-forming optical element by means of light projected from the display placed on said display mounting surface and transmitted through said image-forming optical element.

The present inventor has made studies to solve the aforementioned problem. As a result, the present inventor has found that, by using the panel-shaped optical element having an image-forming function, a two-dimensional image such as a photograph, a video picture (moving image) and the like displayed on the flat panel display are image-formed in a manner floating above (standing up) the case or housing for housing the flat panel display therein, so that the video picture is displayed as a realistic video picture like a stereoscopic image (3D image). Hence, the present inventor has attained the present invention.

In the display device according to the present invention, the flat panel display which displays a video picture is disposed at such an attitude that the display surface thereof is inclined at a predetermined angle with respect to the panel-shaped optical element by the display mounting surface of the mounting stand. Light emitted from the display (light source) is transmitted through the image-forming optical element fitted in the upper surface of the case and the like to form a two-dimensional image appearing three-dimensional over the image-forming optical element (over the upper surface of the panel). Thus, the display device according to the present invention is capable of displaying (projecting) the planar two-dimensional image (photograph and the like) as a pseudo-three-dimensional image having a sense of depth (two-dimensional image appearing three-dimensional) above and apart from the panel-shaped image-forming optical element only by the simple operation of setting the aforementioned flat panel display on the display mounting surface disposed at a predetermined angle.

Either a case that is like a dark box which blocks ambient light and that has the mounting stand disposed inside or an open type housing that has a side surface open and that has one surface used to form the mounting stand and the display mounting surface is preferably used as a container for housing the flat panel display therein. The use of the aforementioned case like a dark box is advantageous in that the aforementioned video picture is projected sharply. The use of the aforementioned open type housing is advantageous in that the aforementioned display is inserted and removed easily.

In particular, the display device according to the present invention wherein the inclination angle of the flat panel display with respect to the lower surface of the panel-shaped image-forming optical element is not less than 30 degrees and less than 90 degrees is capable of displaying the aforementioned two-dimensional image displayed and appearing three-dimensional as an image appearing three-dimensional with a stronger sense of floating.

In particular, the display device according to the present invention wherein the panel-shaped image-forming optical element is a micromirror array including corner reflector type unit optical elements is capable of displaying the aforementioned two-dimensional image displayed and appearing three-dimensional as a sharp image with a higher luminance.

In particular, the display device according to the present invention wherein the flat panel display is a display part for a cellular mobile phone or a personal digital assistant, and the cellular mobile phone or the personal digital assistant is removably disposed on the display mounting surface of the mounting stand is more easily and conveniently used without any special preparation.

The “panel-shaped image-forming optical element” in the display device according to the present invention refers to re fraction type image-forming elements (various lenses including Fresnel lenses and the like, micromirrors of afocal optical systems, corner reflectors, and the like) which form a mirror image of a projected object as a real image, and erect unity-magnification type image-forming elements such as microlens arrays which form an erect unity-magnification image of a projected object as a real image, these image-forming elements being panel-shaped or planar in outside shape, and relatively even and flat in front and back surfaces (upper and lower surfaces). The terms “upper surface” and “lower surface” of the aforementioned panel-shaped image-forming optical element refer to the outside surface and inside surface of the case, the housing or the like, and represent surfaces substantially parallel to the “element surface” of the image-forming optical element and serving as a reference for image formation (a point of refraction of an optical path).

### BRIEF DESCRIPTION OF DRAWINGS

FIG. 1A is an external perspective view of a display device according to a first embodiment of the present invention, and FIG. 1B is a partial sectional view illustrating a method of setting a flat panel display in a case of the display device.

FIG. 2 is a view illustrating a method of projecting a video picture according to the first embodiment.

FIG. 3 is a view showing an internal structure of the display device according to the first embodiment.

FIG. 4 is view illustrating a structure of a micromirror array for use in the aforementioned display device.

FIG. 5 is a sectional view illustrating a detailed structure of the aforementioned micromirror array.

FIG. 6 is a view illustrating a method of projecting a spatial image by means of the aforementioned micromirror array.

FIG. 7 is a view illustrating another example of the structure of the micromirror array for use in the aforementioned display device.

FIG. 8 is an exploded perspective view illustrating the configuration of the aforementioned micromirror array.

FIG. 9 is a view illustrating still another example of the structure of the micromirror array for use in the aforementioned display device.

FIG. 10 is an exploded perspective view illustrating the configuration of the aforementioned micromirror array.

FIG. 11 is a view illustrating still another example of the structure of the micromirror array for use in the aforementioned display device.

FIG. 12 is an exploded perspective view illustrating the configuration of the aforementioned micromirror array.

FIG. 13 is a view illustrating the configuration of a micromirror array having a different structure for use in the aforementioned display device.

FIG. 14 is an external perspective view of the display device according to a second embodiment of the present invention.

FIG. 15 is an external perspective view of the display device according to a third embodiment of the present invention.

FIG. 16 is an external perspective view of the display device according to a fourth embodiment of the present invention.

FIG. 17 is an external perspective view of the display device according to a fifth embodiment of the present invention.

FIG. 18 is an external perspective view of the display device according to a sixth embodiment of the present invention.

FIG. 19 is a sectional view showing the configuration of the display device according to a seventh embodiment of the present invention.

FIG. 20 is a perspective view showing the configuration of the display device according to an eighth embodiment of the present invention.

### DESCRIPTION OF EMBODIMENTS

Next, embodiments according to the present invention will now be described in detail with reference to the drawings. It should be noted that the present invention is not limited to the embodiments.

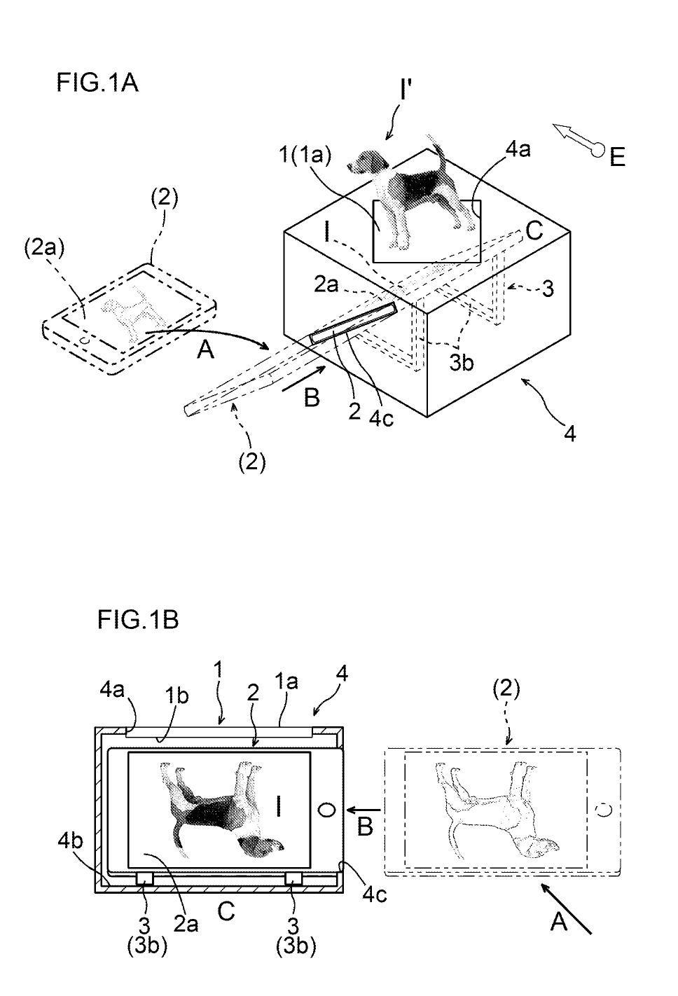

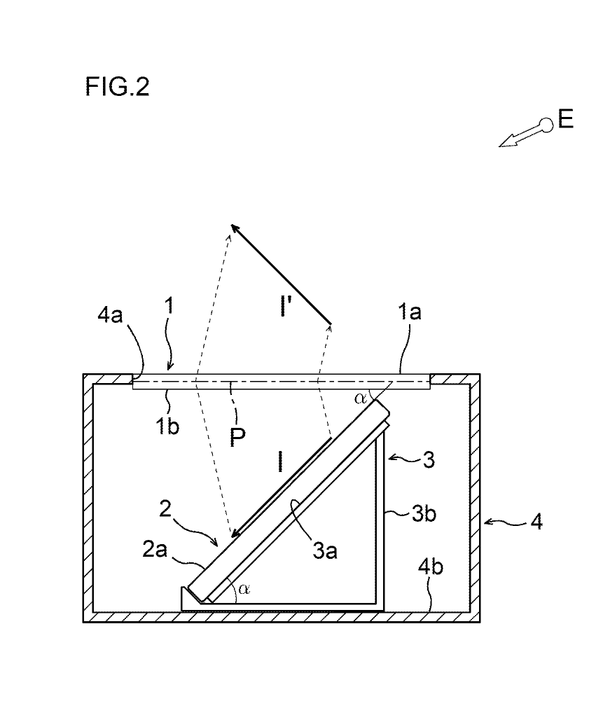

FIG. 1A is an external perspective view of a display device according to a first embodiment of the present invention, and FIG. 1B is a partial sectional view illustrating a method of using the display device. FIG. 2 is a view illustrating an internal structure of the display device and a method of projecting a video picture according to the present invention. It should be noted that the thicknesses of an “image” displayed on a display surface 2a of a flat panel display 2 and a spatial image I′ projected in space (both indicated by thick arrows in FIG. 2) are shown in exaggeration. Also, a liquid crystal display screen (LCD) for a cellular mobile phone (smartphone or the like) is used for the flat panel display 2 in the present example.

The aforementioned display device includes a mounting stand 3 for placing (supporting) the flat panel display 2 thereon, a panel-shaped image-forming optical element 1 having an image-forming function, and a case 4 for housing the aforementioned flat panel display 2 therein. The aforementioned image-forming optical element 1 is fitted in an opening 4a in the upper surface of the aforementioned case 4, and the aforementioned mounting stand 3 is disposed inside the case 4 at such an attitude that a display mounting surface 3a thereof is inclined at a predetermined angle α, as shown in FIG. 2. Using light (backlight) emitted from the display surface 2a of the aforementioned flat panel display 2, an image I on the aforementioned display surface 2a is formed (spatial image I′) thereover by the image-forming function of this image-forming optical element 1. From the eyepoint of a viewer (hollow arrow E side), the aforementioned spatial image I′ can be visually recognized as a spatial image floating above an upper surface (outside surface) 1a of the image-forming optical element 1 and appearing three-dimensional. This is a characteristic of the display device according to the present invention.

The aforementioned display device will be described in further detail. The aforementioned mounting stand 3 includes a plate-like member having an upper surface serving as the display mounting surface 3a, and bases 3b, and is disposed on a bottom 4b side within the case 4. The aforementioned plate-like member is supported and fixed on the aforementioned bases 3b at a predetermined inclined angle α (with reference to FIG. 2) with respect to the bottom 4b of the case 4 and an element surface P of the image-forming optical element 1 (or a lower surface 1b of the image-forming optical element 1). The upper surface of the plate-like member serves as the mounting surface 3a for the flat panel display 2. A smartphone or the like is placed on this display mounting surface 3a, so that the flat panel display 2 is held at such an attitude that the aforementioned display surface 2a is inclined at a degrees with respect to the element surface P of the image-forming optical element 1. It should be noted that the inclination angle α of the aforementioned mounting stand 3 inside the case 4 with respect to the element surface P of the image-forming optical element 1 (and the lower surface 1b inside the case) is adjusted so that the image-forming optical element 1 achieves optimum image formation, and is generally not less than 30 degrees and less than 90 degrees, and preferably in the range of 40 to 80 degrees.

A self light emitting digital clock including a segment LED (reference numeral 5), an LED display and the like is incorporated in the mounting surface 3a of the aforementioned mounting stand 3 at a position where it is hidden (disappears from sight) when the flat panel display 2 is placed on the mounting stand 3. The segment LED 5 and the like are able to display current time, simple information and the like by switching using a switch (not shown) and the like also when the flat panel display 2 is not placed (not used).

Further, when a plurality of types of flat panel displays of different sizes are used in combination as the flat panel displays (cellular mobile phones, smartphones and the like) to be placed on the mounting stand 3, a plurality of mounting stands (or display mounting surfaces 3a) of different dimensions may be disposed inside the case 4 in accordance with the sizes of the smartphones and the like. Also, the individual mounting stands may be variable or movable. When the aforementioned segment LED 5 and the like are not disposed in the mounting surface 3a, an adhesive tape or the like for temporarily fixing the flat panel display 2 may be attached to this mounting surface 3a.

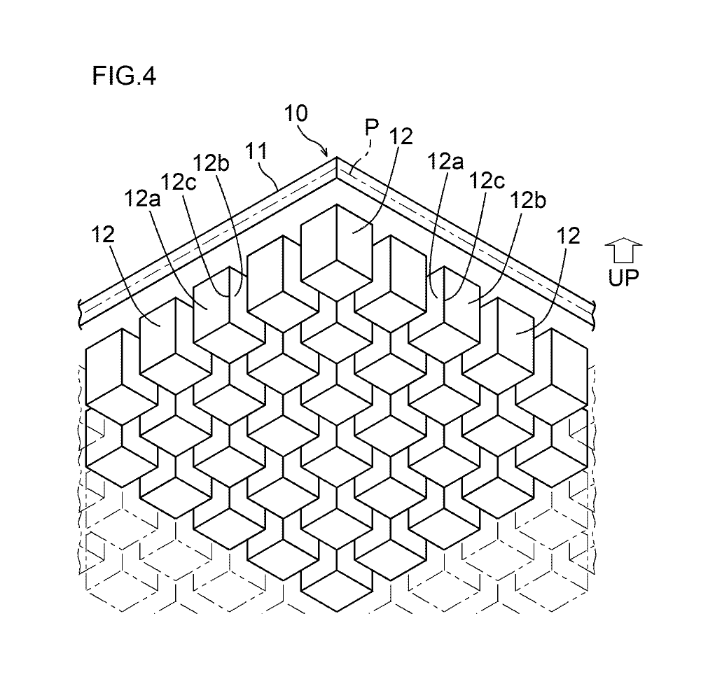

Next, examples of the image-forming optical element 1 for use in the aforementioned display device include: refraction type image-forming elements such as various lenses including Fresnel lenses and the like, micromirrors of afocal optical systems, and corner reflectors; and erect unity-magnification type image-forming elements such as microlens arrays. Of these, a micromirror array (protruding corner reflector array, with reference to FIG. 4 for detailed structure) which forms an image at a position symmetrical thereto with respect to the plane of the element surface P, as shown in FIG. 2, is preferably used in the present embodiment. This micromirror array 10 is fitted in the opening 4a provided in the upper surface of the aforementioned case 4 and is fixed thereto.

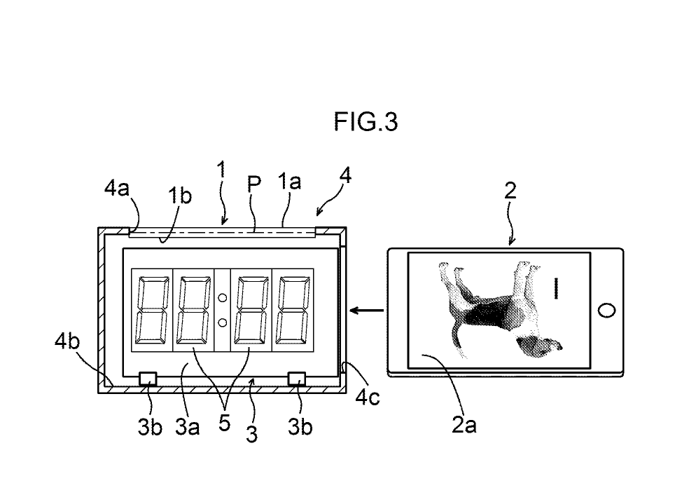

The aforementioned micromirror array (corner reflector array) 10 will be described in further detail. As shown in the enlarged schematic view of FIG. 4, this micromirror array 10 includes a multiplicity of downwardly protruding minute unit optical elements 12 (corner reflectors) in the shape of quadrangular prisms which are provided on the lower surface (the lower surface 1b side of the image-forming optical element 1 in FIGS. 1 to 3) of a substrate (base) 11 and arranged in a diagonal checkerboard pattern. FIG. 4 is a view of the array as seen in an upward direction from below.

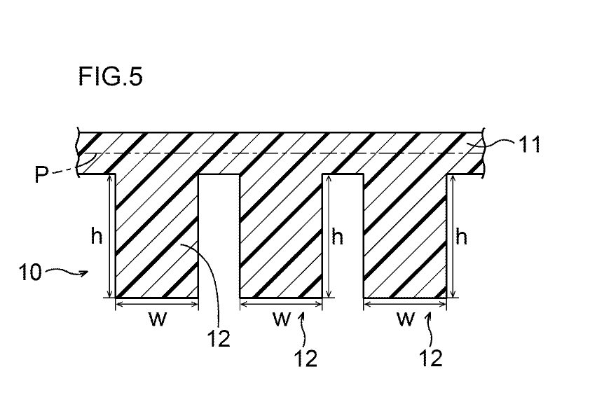

As shown in cross section in FIG. 5, each of the unit optical elements 12 in the shape of quadrangular prisms in the aforementioned micromirror array 10 has a pair of two light reflecting surfaces (a first side surface 12a and a second side surface 12b on the lateral sides of the quadrangular prism) constituting a corner reflector. Each of the light reflecting surfaces is of a rectangular shape having the “ratio of the length (height h) as measured in the direction of the thickness of the substrate to the width (width w) as measured in the direction of the surface of the substrate” [aspect ratio (h/w)] of not less than 1.5.

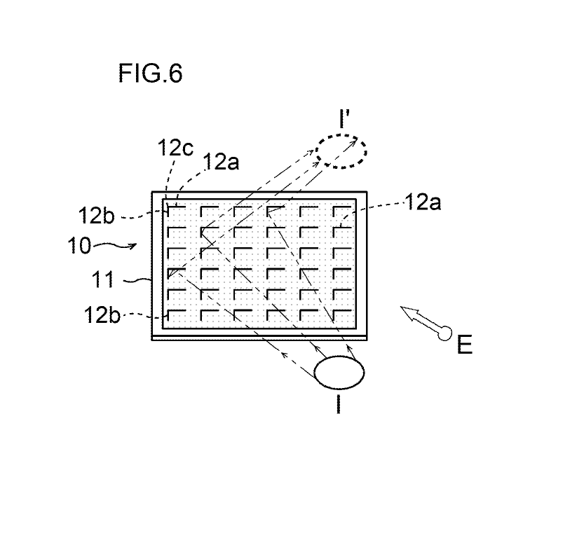

The pair of light reflecting surfaces (the first side surface 12a and the second side surface 12b) which form a corner 12c of each of the unit optical elements 12 are designed to face toward the eyepoint of the viewer (E side in FIGS. 1 and 2). When this micromirror array 10 and its surroundings are viewed from above, the aforementioned array 10 is disposed with the outer edges thereof rotated 45 degrees with respect to the front of the viewer (the direction E), as shown in FIG. 6. The image I under the micromirror array 10 is projected onto a position (above the image-forming optical element) symmetrical thereto with respect to the plane of the array 10 (element surface P), so that the spatial image I′ is formed.

Next, examples of the flat panel display 2 for use in displaying the aforementioned image I may include display panels capable of reproducing “white” as balanced as possible over all visible wavelengths and “black” when in a non-display state with good contrast, such as plasma display panels and organic EL display panels, in addition to liquid crystal displays (LCDs) with backlights. The flat panel display 2 may be a display part for a cellular mobile phone, a personal digital assistant or the like. Specifically, normally exposed (uncovered) type display parts of smartphones, tablet PCs, digital photo frames, portable game machines, portable book readers, PDAs, electronic dictionaries and the like which are sized to be placeable on the aforementioned mounting stand 3 may be used as the aforementioned flat panel display 2. Also, displays which produce colors using reflected light by means of external light sources and cathode ray tube type displays may be used.

As shown in FIGS. 1A and 1B, the image-forming optical element 1 (micromirror array 10) of a substantially square shape is fitted in the opening 4a in the upper surface of the case 4 for housing the aforementioned mounting stand 3 therein. An insertion opening 4c through which the flat panel display 2 (smartphone in the figure) is horizontally slid into and out of the case 4 (onto and off the mounting stand 3) is provided in one side surface of the case 4. The inside surfaces of the case 4, except the area of the aforementioned image-forming optical element 1, have a black color (a chromaticity of 0; a saturation of 0; and a lightness of 0) or a dark color close to the black color for the purpose of preventing irregular reflection of light.

A sound-producing means such as a speaker may be provided on part of the aforementioned case 4. This sound-producing means allows the output of music (background music), voices and the like in harmony with the image I displayed on the aforementioned flat panel display 2. Of course, a speaker or the like built in the aforementioned smartphone (flat panel display 2) may be used.

For display (projection) of the aforementioned image I in the aforementioned display device, a smartphone provided with the flat panel display 2 is initially prepared, and the image I subjected to predetermined processing (image processing to be described later) is displayed on this flat panel display 2. Then, this smartphone is moved to near the side surface of the case 4 where the aforementioned insertion opening 4c is provided (with reference to the arrow A in FIG. 1A), with the aforementioned image I positioned upside down.

Next, with the aforementioned image I in the inverted position, the aforementioned smartphone is pushed into the case 4 through the aforementioned insertion opening 4c (the arrow B in FIGS. 1A and 1B). Then, this smartphone is horizontally slid on the mounting surface and is set at a predetermined position on the mounting stand 3 (position C in FIGS. 1A and 1B). Thus, the planar two-dimensional image I (photograph or the like) displayed on the screen of the aforementioned flat panel display 2 is displayed (projected) as the spatial image I′ having a sense of depth (two-dimensional image appearing three-dimensional) above the panel-shaped image-forming optical element 1 (micromirror array 10), with reference to FIG. 1A.

When the aforementioned smartphone (flat panel display 2) is set in such a state that images displayed thereon automatically change one after another (what is called a “slide show” mode), arbitrary favorite images I may be displayed (projected) in sequential order without manipulating this flat panel display 2 inside the aforementioned case 4. When the aforementioned mounting stand 3 is configured to serve also as a battery charger (charging stand or cradle) for the aforementioned cellular mobile phone, the personal digital assistant and the like, it is possible to accomplish the charging for each device while the aforementioned images I are being displayed. This achieves the effective use of the time for the charging. Additionally, when the speaker or the like is provided as described above, music (background music), voices and the like may be outputted from the speaker or the like in harmony with the images I displayed on the aforementioned flat panel display 2.

Next, the processing (image processing) of the image I to be displayed which is previously performed before the setting on the aforementioned mounting stand 3 will be described.

Data (electronic data) about a photograph and an image for use in a conventional display device for image viewing may be used without any processing (as it is) as the image I for the display device according to the present invention. When part of an image such as a human figure, a specific object and the like in an image is desired to be emphasized (extracted) for display, the processing performed on the aforementioned photograph, image data and the like by image processing (to be described later) before the use thereof allows the spatial image I′ displayed by the aforementioned display device to be displayed more sharply as an image appearing three-dimensional with a stronger sense of floating in an emphasized manner. A procedure therefor will be described below.

(1) Acquisition of Image Data (Electronic Data)

In a device incorporating a digital camera such as a smartphone, a tablet PC, a portable game machine and a PDA, image data (I) is acquired using a digital camera. In the case of a device incorporating no digital camera, data is inputted to the device by using other optical devices such as a scanner and a digital camera.

(2) Cropping and Blurring Process

Image processing software (application) capable of handling raster data is used to recognize (identify) the outline of a human figure, an object to be displayed and the like, and to cut out data (cropping). A “blurring process” which randomly levels the color tones near outer edges (near the outline) is performed on the data. In the case of a smartphone, a tablet PC and the like, an application installed (or downloaded) therein may be used.

(3) Background Process

The image data after the completion of the aforementioned cropping is combined with a background having a single color (preferably black, white or the color of the upper surface of the case), and the size and position of a portion (the aforementioned data subjected to the cropping) desired to be emphasized in the image I to be displayed are adjusted on the screen. The selection of the “color of the upper surface of the case” around the image-forming optical element as the aforementioned background color to be combined is preferable because this color increases the three-dimensional effect of the aforementioned spatial image I′.

(4) Contrast Control

Image processing software is used to control the “brightness”, “tint” and “contrast” of the data obtained by the combination of the aforementioned image and the background before the data is displayed. At this time, it is desirable to make corrections such that the gray level of each color of RGB (256 gray levels) having a gray level of not less than 150 (or not less than 200) is increased to 256 (maximum) and the gray level of each color thereof having a gray level of not more than 100 (or not less than 10) is decreased to 0 (minimum). This further emphasizes the contrast (a sense of floating) of the aforementioned image. The adjustment of the aforementioned image may be performed while referencing (feeding back) a printed result, based on test display.

Using the image I subjected to the aforementioned image processing, the flat panel display 2 which displays the image is set on the display mounting surface 3a so that the image is positioned upside down, as described above, and disposed at a predetermined position inside the case 4 at a predetermined inclined angle α. This allows the aforementioned image I shown in two-dimension to be displayed (projected) as a more realistic spatial image I′ (two-dimensional image appearing three-dimensional).

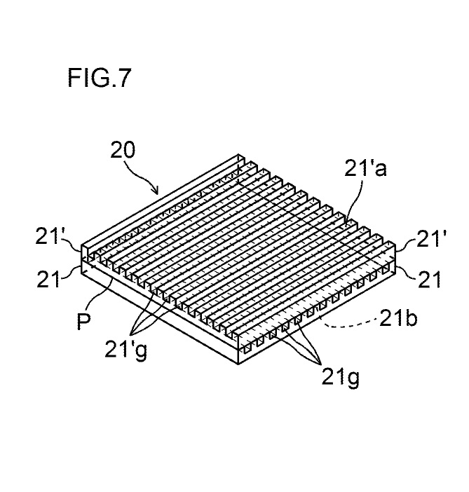

One or two optical elements (micromirror arrays 20, 30, 40 and 50 with reference to FIGS. 7 to 13) obtained by forming a plurality of parallel linear grooves spaced at predetermined intervals by dicing using a rotary blade in a surface of a flat-shaped transparent substrate, in addition to the micromirror array 10 having the aforementioned structure, may be used as the panel-shaped image-forming optical element 1 for the display device according to the present invention.

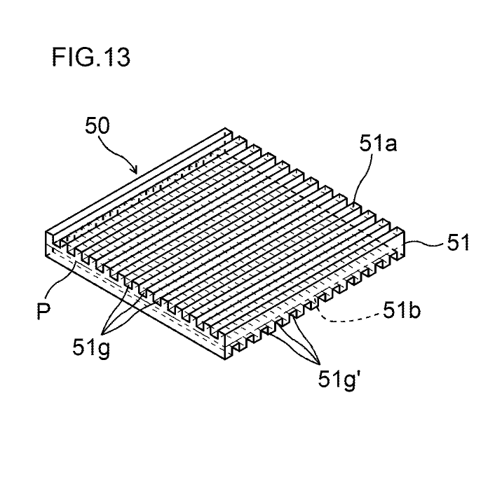

In these micromirror arrays 20, 30, 40 and 50, the two optical elements (substrates) having the plurality of parallel grooves formed in the front surfaces thereof are laid one on top of the other, with one of the optical elements rotated through 90 degrees (FIGS. 7, 9 and 11), or the one flat-shaped substrate has the plurality of parallel grooves formed in the front and back surfaces thereof so as to be orthogonal to each other as seen in plan view (FIG. 13). As a result, as seen in the direction of the front and back surfaces of the substrate (s) (in a vertical direction), corner reflectors are formed respectively at the intersections (points of intersection of a lattice) of a first group of parallel grooves and a second group of parallel grooves which are orthogonal to each other as seen in plan view. The corner reflectors are comprised of light-reflective vertical surfaces (wall surfaces) of the first group of parallel grooves, and light-reflective vertical surfaces (wall surfaces) of the second group of parallel grooves.

The light-reflective wall surfaces of the first group of parallel grooves of the substrate and the light-reflective wall surfaces of the second group of parallel grooves of the substrate which constitute the aforementioned corner reflectors are in what is called a “skew” relation, as seen three-dimensionally. It is also advantageous that the adjustment of the optical performance of the optical elements, such as an increase in aspect ratio [height (length as measured in the direction of the thickness of the substrate)/width (width as measured in a horizontal direction of the substrate)] of the light reflecting surfaces of the aforementioned corner reflectors, is made relatively easily because the aforementioned parallel grooves and the light-reflective wall surfaces thereof are formed by dicing using a rotary blade.

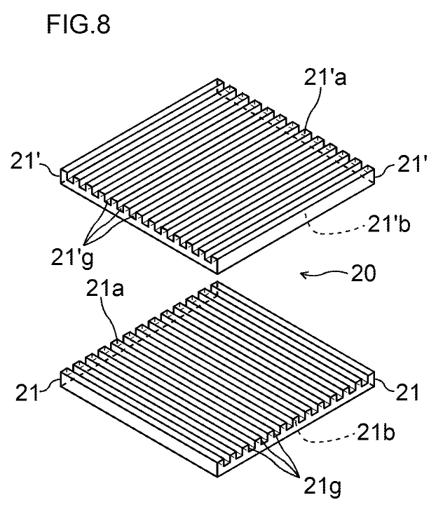

The structures of the aforementioned respective micromirror arrays will be described individually in further detail. Optical elements (21 and 21′) constituting the micromirror array 20 shown in FIGS. 7 and 8 are configured such that a plurality of parallel linear grooves 21g or grooves 21′g spaced at predetermined intervals are formed by dicing using a rotary blade in upper surfaces 21a and 21′a of flat-shaped transparent substrates 21 and 21′. The aforementioned micromirror array 20 is formed using the two optical elements (substrates 21 and 21′) identical in shape. With the upper substrate 21′ rotated relative to the lower substrate 21 so that the continuous directions of the grooves 21g and the grooves 21′g provided on the substrates 21 and 21′ are orthogonal to each other as seen in plan view, a back surface 21′b (where the grooves 21′g are not formed) of the upper substrate 21′ is brought into abutment with the front surface 21a of the lower substrate 21 where the grooves 21g are formed. These substrates 21 and 21′ are vertically laid one on top of the other and fixed together to constitute the single array 20.

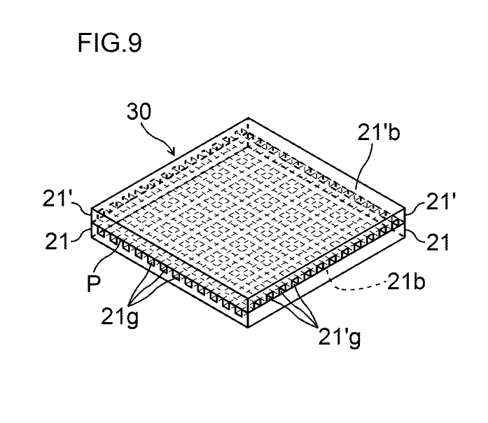

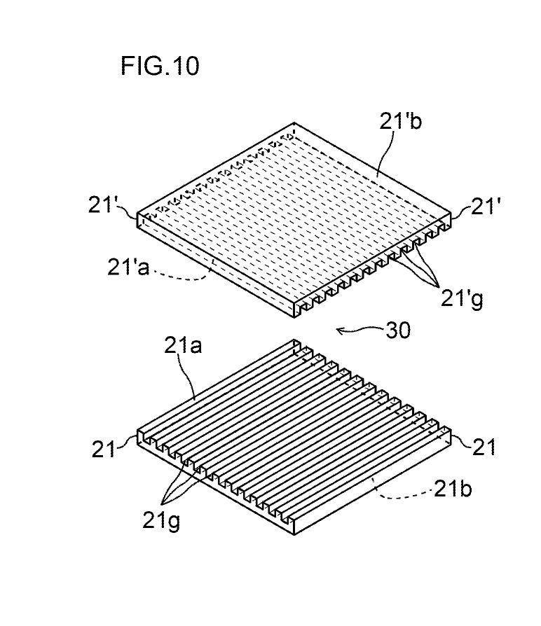

Similarly, the micromirror array 30 shown in FIG. 9 is formed using two optical elements (substrates 21 and 21′) identical in shape and in manufacturing method with those described above. As shown in FIG. 10, with the upper substrate 21′ flipped upside down and rotated 90 degrees relative to the lower substrate 21, the front surface 21′a of the substrate 21′ where the grooves 21′g are formed is brought into abutment with the front surface 21a of the lower substrate 21 where the grooves 21g are formed. These substrates 21 and 21′ are vertically laid one on top of the other and fixed together to constitute the single array 30 in which the continuous directions of the grooves 21g and the grooves 21′g provided on the substrates 21 and 21′ are orthogonal to each other as seen in plan view.

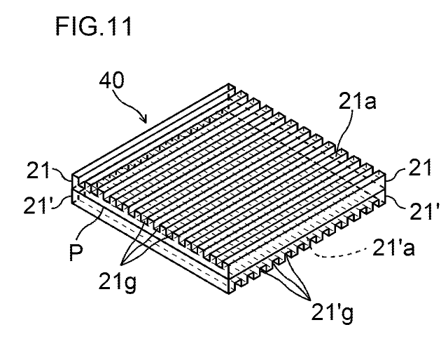

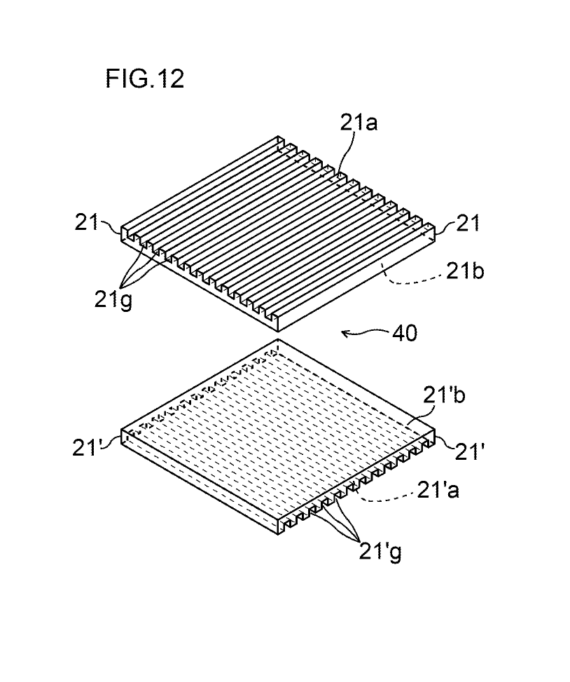

Further, the micromirror array 40 shown in FIG. 11 is formed using two optical elements (substrates 21 and 21′) identical in shape and in manufacturing method with those described above. As shown in FIG. 12, with the lower substrate 21′ flipped upside down and rotated 90 degrees relative to the upper substrate 21, a back surface 21b of the substrate 21 and the back surface 21′b of the substrate 21′ are brought into abutment with each other. These substrates 21 and 21′ are vertically laid one on top of the other and fixed together to constitute the single array 40 in which the continuous directions of the grooves 21g and the grooves 21′g provided on the substrates 21 and 21′ are orthogonal to each other as seen in plan view.

The micromirror array 50 shown in FIG. 13 is configured such that a plurality of parallel linear grooves 51g and grooves 51g′ spaced at predetermined intervals are formed by dicing using a rotary blade in an upper front surface 51a and a lower back surface 51b, respectively, of a flat-shaped transparent substrate 51. The formation directions (continuous directions) of the grooves 51g on the front surface 51a side and the grooves 51g′ on the back surface 51b side are orthogonal to each other as seen in plan view.

Like the display device including the aforementioned micromirror array 10, a display device including each of the aforementioned micromirror arrays 20, 30, 40 and 50 is also capable of displaying (projecting) the planar image I shown in two-dimension (photograph or the like) placed on the mounting stand 3 as a pseudo-three-dimensional image having a sense of depth (two-dimensional image I′ appearing three-dimensional). Further, the aforementioned display device is advantageous in that the costs of the entire device are reduced because the micromirror arrays (20, 30, 40 and 50) used therein are less costly.

Next, instances in which open type housings (14 to 18) having no side surfaces are used in place of the aforementioned closed type case 4 as a container for housing the flat panel display 2 will be described. It should be noted that the shape and the like of the case or housings for use in the display device according to the present invention are not limited to those of these embodiments.

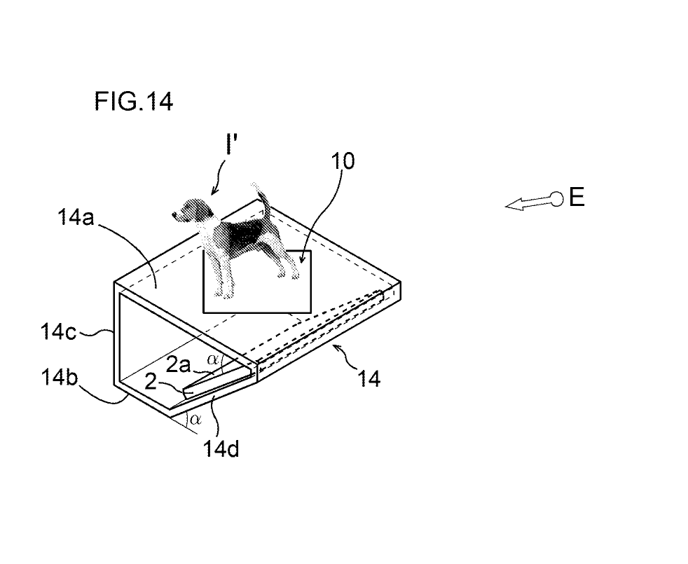

FIGS. 14 to 18 are external perspective views of the display devices according to second to sixth embodiments, respectively, of the present invention. The spatial image I′ (in this example, a photograph of a dog) projected above the micromirror array is not shown except in FIG. 14. The components of the display devices except the housings (14 to 18) and the display mounting surface according to the second to sixth embodiments, which are similar to those of the display device according to the first embodiment described above, are designated by the same reference numerals and characters as in the first embodiment, and will not be described in detail.

First, as shown in FIG. 14, the housing 14 which includes a top plate portion 14a, a bottom plate portion 14b, a side plate portion (vertical) 14c and a sloping side portion (sloping plate portion 14d) and which has no side surfaces (side portions) lateral to the display (as seen in a display insertion direction) is used for the display device according to the second embodiment. The micromirror array 10 (which may be 20, 30, 40 or 50) similar to that of the first embodiment is disposed in an opening provided in the upper surface (top plate portion 14a) of this housing 14. The upper surface (inside surface) of the sloping plate portion 14d positioned under the micromirror array 10 is formed as a mounting stand (display mounting surface) for placing the flat panel display 2 thereon.

Like the display mounting surface 3a of the mounting stand 3 in the aforementioned first embodiment, the aforementioned sloping plate portion 14d is formed at a predetermined inclined angle α with respect to the bottom plate portion 14b of the housing 14 and the element surface of the micromirror array 10 (or the lower surface thereof), and an adhesive tape or the like (not shown) for temporarily fixing the flat panel display 2 is attached to the upper surface thereof (display mounting surface).

With the aforementioned configuration, this display device is capable of displaying (projecting) the planar two-dimensional image as a pseudo-three-dimensional image having a sense of depth (two-dimensional image appearing three-dimensional) above the micromirror array 10 only by the simple operation of setting the aforementioned flat panel display 2 on the display mounting surface (housing inside surface of the sloping plate portion 14d) set at the predetermined inclined angle α. Additionally, the housing 14 of the aforementioned display device has wide-open side surfaces. This is advantageous in allowing easy and simple insertion, removal and the like of the aforementioned display 2 (smartphone or the like).

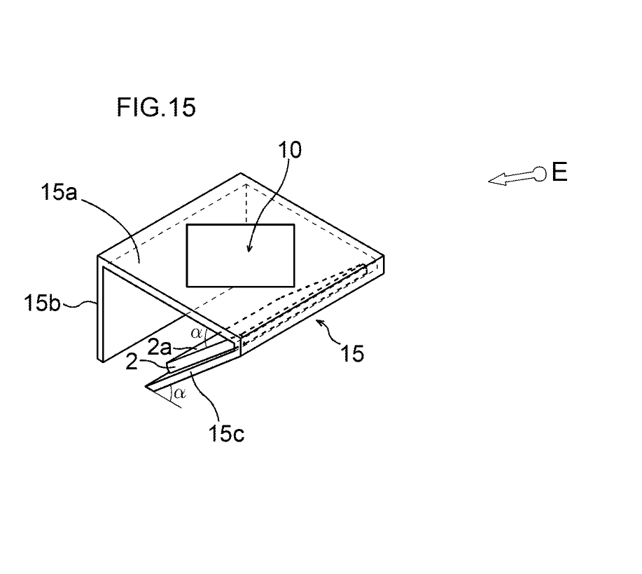

Next, as shown in FIG. 15, the housing 15 which includes a top plate portion 15a, a side plate portion (vertical) 15b and a sloping side portion (sloping plate portion 15c) and which has no bottom plate and no side surfaces lateral to the display is used for the display device according to the third embodiment. The micromirror array 10 (which may be 20, 30, 40 or 50) is disposed in an opening provided in the upper surface (top plate portion 15a) of this housing 15. The upper surface (inside surface) of the sloping plate portion 15c positioned under the micromirror array 10 is formed as a mounting stand (display mounting surface) for placing the flat panel display 2 thereon.

The aforementioned sloping plate portion 15c is formed at a predetermined inclined angle α with respect to the lower surface of the device and the element surface of the micromirror array 10 (or the lower surface thereof), and an adhesive tape or the like (not shown) for temporarily fixing the flat panel display 2 is attached to the upper surface thereof (display mounting surface).

With this configuration, the planar two-dimensional image is displayed (projected) as a pseudo-three-dimensional image having a sense of depth (two-dimensional image appearing three-dimensional) only by setting the aforementioned flat panel display 2 on the display mounting surface (housing inside surface of the sloping plate portion 15c) set at the predetermined inclined angle α. Additionally, the housing 15 of this configuration has wide-open side surfaces. This allows easy insertion and removal of the aforementioned display 2 (smartphone or the like) through the openings.

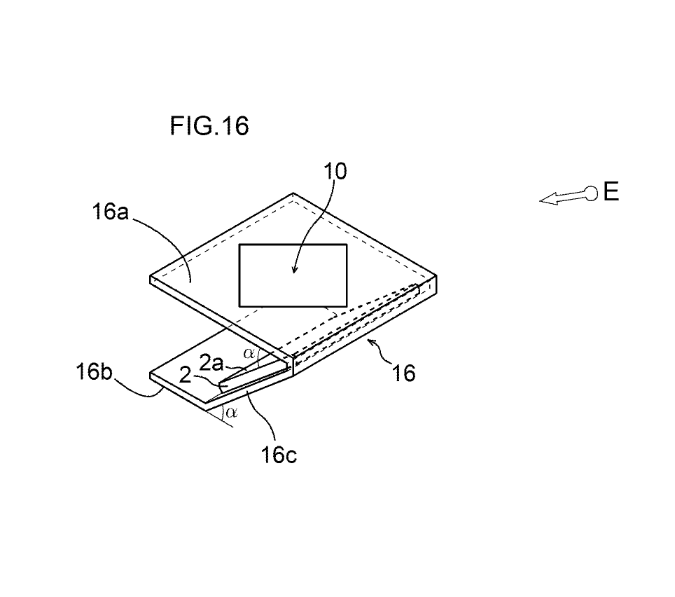

Next, as shown in FIG. 16, the housing 16 which includes a top plate portion 16a, a bottom plate portion 16b and a sloping side portion (sloping plate portion 16c) and which has no vertical side surface (side plate) and no side surfaces lateral to the display is used for the display device according to the fourth embodiment. The micromirror array 10 (which may be 20, 30, 40 or 50) is disposed in an opening provided in the upper surface (top plate portion 16a) of this housing 16. The upper surface (inside surface) of the sloping plate portion 16c positioned under the micromirror array 10 is formed as a mounting stand (display mounting surface) for placing the flat panel display 2 thereon.

The aforementioned sloping plate portion 16c is formed at a predetermined inclined angle α with respect to the bottom plate portion 16b and the element surface of the micromirror array 10 (or the lower surface thereof), and an adhesive tape or the like (not shown) for temporarily fixing the flat panel display 2 is similarly attached to the upper surface thereof (display mounting surface).

With the aforementioned configuration, the planar two-dimensional image is displayed (projected) as a pseudo-three-dimensional image having a sense of depth (two-dimensional image appearing three-dimensional) only by setting the aforementioned flat panel display 2 on the display mounting surface (housing inside surface of the sloping plate portion 16c) set at the predetermined inclined angle α. Additionally, the housing 16 of this configuration has wide-open side surfaces (three surfaces). This allows easy insertion and removal of the aforementioned display 2 (smartphone or the like) through the openings.

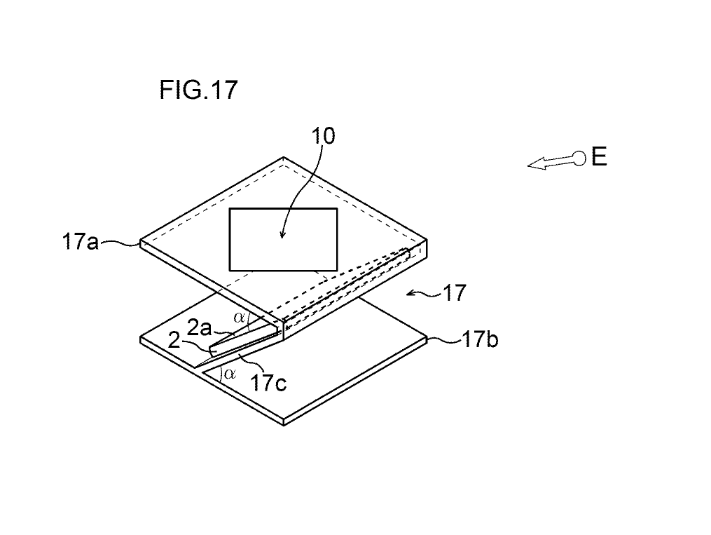

Next, as shown in FIG. 17, the housing 17 in which a sloping plate portion 17c which supports a substantially horizontal top plate portion 17a and a bottom plate portion 17b is provided between the top plate portion 17a and the bottom plate portion 17b is used for the display device according to the fifth embodiment. The micromirror array 10 (which may be 20, 30, 40 or 50) is disposed in an opening provided in the upper surface (top plate portion 17a) of this housing 17.

The sloping plate portion 17c positioned under the aforementioned micromirror array 10 is formed at a predetermined inclined angle α with respect to the bottom plate portion 17b and the element surface of the micromirror array 10 (or the lower surface thereof), and an adhesive tape or the like (not shown) for temporarily fixing the flat panel display 2 is attached to the upper surface thereof (display mounting surface).

With the aforementioned configuration, the planar two-dimensional image is displayed (projected) as a pseudo-three-dimensional image having a sense of depth (two-dimensional image appearing three-dimensional) only by setting the flat panel display 2 on the display mounting surface (housing inside surface of the sloping plate portion 17c) set at the predetermined inclined angle α. Additionally, the housing 17 of this configuration has wide-open side surfaces (three surfaces). This is characteristic in allowing easy insertion and removal of the aforementioned display 2 (smartphone or the like) through the openings.

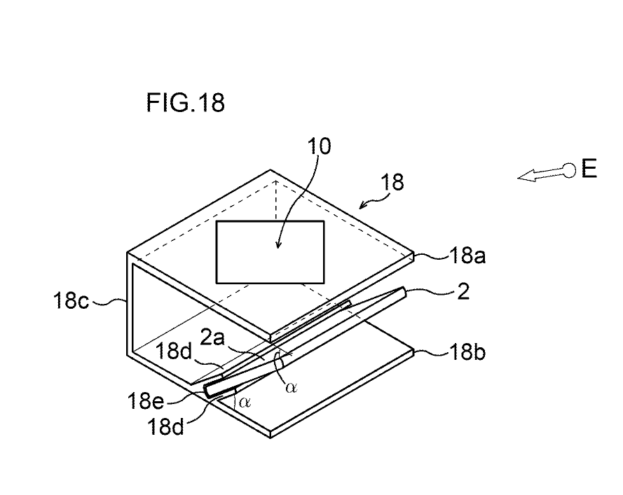

Next, as shown in FIG. 18, the housing 18 which includes a top plate portion 18a, a bottom plate portion 18b and a side plate portion (vertical) 18c and which has no side surfaces (side portions) lateral to the display as in the aforementioned second embodiment is used for the display device according to the sixth embodiment. The micromirror array 10 (which may be 20, 30, 40 or 50) is disposed in an opening provided in the upper surface (top plate portion 18a) of this housing 18.

A pair of short sloping plates 18d inclined at a predetermined angle α are provided on the bottom plate portion 18b of this housing 18. A groove 18e formed between these sloping plates 18d allows an edge of the flat panel display 2 to be fitted therein.

With the aforementioned configuration, the aforementioned flat panel display 2 is held with stability at the predetermined inclined angle α with respect to the element surface of the micromirror array 10 (or the lower surface thereof). Thus, this display device is also capable of displaying (projecting) the planar two-dimensional image as a pseudo-three-dimensional image having a sense of depth (two-dimensional image appearing three-dimensional) above the micromirror array 10 only by the simple operation of setting the aforementioned display 2 between the aforementioned sloping plates 18d. This allows easy and simple insertion, removal, replacement and the like of the aforementioned display 2 (smartphone or the like).

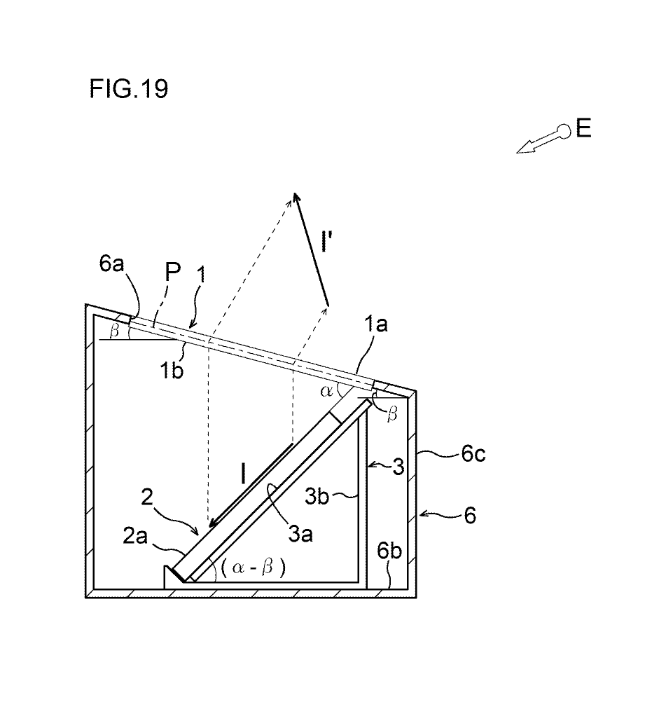

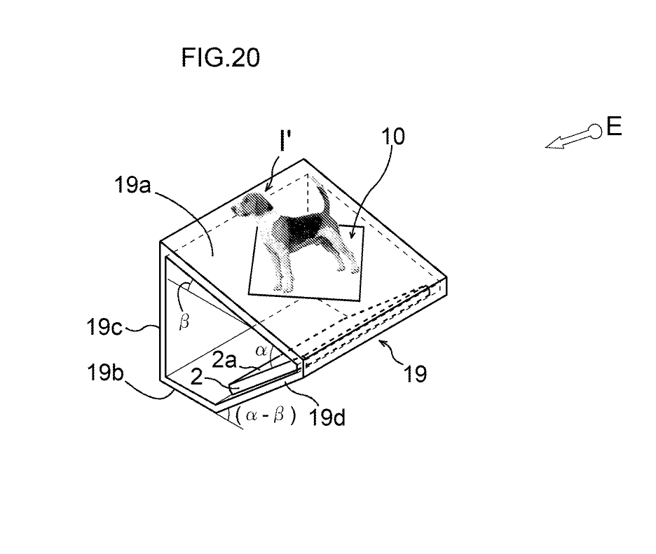

Next, the display devices (seventh and eighth embodiments) in which the aforementioned case (reference numeral 4) or the housings (reference numerals 14 to 18) have an oblique upper surface will be described. FIG. 19 is a view showing an inside structure of the display device according to the seventh embodiment of the present invention, and FIG. 20 is a view showing the configuration of the display device according to the eighth embodiment of the present invention. Components having functions similar to those of the aforementioned embodiments are designated by the same reference numerals and characters, and will not be described in detail.

The display devices according to the aforementioned seventh and eighth embodiments have a structural characteristic in that the upper surface of a case 6 or a housing 19 for housing the aforementioned flat panel display 2 therein is formed as an “upwardly inclined surface” inclined from the front side of the device (on the right-hand side as seen in the figures) on the near side for a viewer (E side) toward the rear side of the device (on the left-hand side as seen in the figures) on the far side. Specifically, in the case of the display device according to the seventh embodiment shown in FIG. 19, the upper surface in which the image-forming optical element 1 (micromirror array) is fitted is an inclined surface upwardly inclined at a predetermined angle β with respect to the horizontal surface of the device (horizontal surface sensed by the viewer) toward the direction of inclination identical with the inclination of the aforementioned spatial image I′ (E side where the viewer is present).

Also in this instance, the display mounting surface 3a, on the mounting stand 3 on which the flat panel display 2 is disposed, is disposed at a predetermined inclined angle α with respect to the element surface P of the aforementioned image-forming optical element 1 (or the lower surface 1b thereof), and the image I on the display 2 is formed as the spatial image I′ at a position symmetrical thereto with respect to the plane of the element surface P of the image-forming optical element 1. Thus, the inclination angle of the aforementioned display mounting surface 3a with respect to a bottom surface 6b of the case 6 is expressed as (α−β).

Also, in the case of the display device according to the eighth embodiment shown in FIG. 20, a top plate portion 19a in which the micromirror array 10 is fitted is an inclined surface upwardly inclined at a predetermined angle β toward the direction of inclination identical with the inclination of the aforementioned spatial image I′, that is, from the near side (front side) toward the far side (rear side) with respect to the horizontal surface of the device (horizontal surface sensed by the viewer) as viewed from the viewer (E side). Other structures are similar to those of the display device of the second embodiment (housing 14) shown in FIG. 14.

The inclination angle β of the upper surface of the aforementioned case 6 and the housing 19 with respect to the horizontal is generally in the range of 1 to 60 degrees (15 degrees in these instances), and is not more than the inclination angle α (not less than 30 degrees and less than 90 degrees) of the aforementioned flat panel display 2 and the display mounting surface 3a with respect to the image-forming optical element 1 (micromirror array 10). The inclination angle β and the inclination angle α satisfy the following relation:

0<γ≦α (where 1°≦β≦60° and 30°≦α<90°)

As described above, the display devices in which the upper surface is the inclined surface allow anyone to easily find the “front surface of the device) (near side) suitable for the viewing of the spatial image I′ because of the direction of the inclination of the upper surface of the case, the housing and the like. This allows anyone to easily find the direction and position optimum for viewing where he/she most feels the three-dimensional effect of the aforementioned spatial image I′ without thought. Further, the viewing direction and position are the position where a sense of floating, a sense of realism and the like of the spatial image I′ are felt strongest in the aforementioned display device.

Furthermore, the configurations of these display devices cause binocular parallax which enhances a sense of depth, a sense of floating, a sense of realism and the like of the spatial image I′ between the spatial image I′ standing up obliquely and the upper surface of the case, the housing and the like positioned behind the spatial image I′. This increases the contrast and sharpness of the spatial image I′ (a video picture, an image and the like) to allow the visual recognition of this spatial image I′ from a longer distance. Of course, the configuration in which the upper surface of the aforementioned case and the like is the upwardly inclined surface toward the viewer may be applied to other embodiments.

Although specific forms in the present invention have been described in the aforementioned embodiments, the aforementioned embodiments should be considered as merely illustrative and not restrictive. It is contemplated that various modifications evident to those skilled in the art could be made without departing from the scope of the present invention.

The display device according to the present invention is capable of displaying a two-dimensional image rich in a sense of depth and appearing realistically three-dimensional in a manner floating up over the body of the device.

### REFERENCE SIGNS LIST

1 Image-forming optical element
1b Lower surface
2 Flat panel display
3 Mounting stand
3a Display mounting surface
4 Case
I Image
I′ Spatial image

1. A display device, comprising:
a mounting stand having a display mounting surface for removably placing an electronic device having a flat panel display thereon;
a panel-shaped image-forming optical element; and
a case for housing said electronic device therein,
wherein said image-forming optical element is disposed on an upper surface of the case, wherein said display mounting surface is disposed under the image-forming optical element at a predetermined inclined angle with respect to a lower surface of said image-forming optical element, and
wherein a projected image of a picture displayed on said display is capable of being image-formed in a manner floating above the image-forming optical element by light projected from the display of the electronic device placed on said display mounting surface and transmitted through said image-forming optical element.

2. The display device according to claim 1, wherein said case is a dark box which blocks ambient light, and said mounting stand is disposed inside the case.

3. The display device according to claim 1, wherein said case is an open housing with a side surface open, and said mounting stand and the display mounting surface are formed using one surface of the housing.

4. The display device according to claim 1, wherein the inclination angle of said flat panel display of the electronic device, when mounted on said display mounting surface, with respect to the lower surface of said panel-shaped image-forming optical element is not less than 30 degrees and less than 90 degrees.

5. The display device according to claim 1, wherein said panel-shaped image-forming optical element is a micromirror array including corner reflector type unit optical elements.

6. The display device according to claim 1, wherein said flat panel display is at least one selected from the group consisting of liquid crystal displays, plasma display panels, organic EL display panels, display part for a cellular mobile phone and display part for personal digital assistant.
